(19) United States
(12) Patent Application Publication
(10) Pub. No.: US 2026/0243791 A1
(43) Pub. Date: Aug. 20, 2026

(54) LIQUID HANDLING PROBE ASSEMBLY WITH POROUS AND SOLID FEATURES

(71) Applicant: Mott Corporation, Farmington, CT (US)

(72) Inventors: Vincent Palumbo, East Granby, CT (US); David Gonthier, Middletown, CT (US); Nathan Donahue, Kensington, CT (US)

(21) Appl. No.: 19/159,871

(22) PCT Filed: Mar. 7, 2024
(86) PCT No.: PCT/US2024/018793

§ 371 Date: Aug. 26, 2025

Related U.S. Application Data
(60) Provisional application No. 63/450,435, filed on Mar. 7, 2023.

(51) Int. Cl. G01N 35/10

(52) U.S. Cl. CPC G01N 35/10

(57) ABSTRACT

Liquid handling probe assemblies and systems having porous metal and solid metal features are described. At least a portion of the liquid handling probe assembly can be manufactured via additive manufacturing (e.g., laser powder bed fusion).

### CROSS-REFERENCE TO RELATED APPLICATION

This application claims priority to U.S. Provisional Application No. 63/450,435, filed Mar. 7, 2023, which incorporated by reference herein in its entirety.

### TECHNICAL FIELD

This disclosure relates to liquid handling probe assemblies, systems, methods of fabrication, and uses thereof.

### BACKGROUND

Liquid handling probes, also known as liquid handler probes, needle probes, or sampling probes, are used to obtain a sample of a liquid, for example for analysis or other processing, or to transfer a liquid, for example to dispense multiple quantities of a liquid. The probes are generally provided as an assembly with a liquid storing element. The liquid handling probes can have a variety of configurations, and are generally manufactured from solid or porous materials. A number of different types of liquid handling probes and assemblies are commercially available. Nonetheless, there remains a need among manufacturers and users to develop liquid handling probe assemblies and related technologies that are one or more of cost-effective, or have improved features, or improved structures.

### SUMMARY

A liquid handling probe assembly comprising a porous metal tip for passage of a fluid and having apex end and a base end; and a tube comprising a solid metal that defines a center for passage of a fluid, wherein the base end of the porous metal tip is adjacent the first end the tube and in fluid communication.

A method of transferring a liquid includes contacting the apex end of the tip comprising a porous metal of the liquid handling probe of assembly with a liquid to be transferred; drawing the liquid into the tip; drawing the liquid from the tip to the center of the tube; and optionally, drawing the liquid from the second end of the tube.

A method for fabricating the liquid handling probe assembly includes manufacturing at least a portion, or all of the liquid handling probe assembly by additive manufacturing, for example by laser bed powder fusion.

The above described and other features are exemplified by the following figures and detailed description.

Any combination or permutation of embodiments is envisioned. Additional features, functions and applications of the disclosed systems, assemblies, methods, and uses of the liquid handling probe assemblies will be apparent from the description which follows, particularly when read in conjunction with the appended figures.

### BRIEF DESCRIPTION OF THE DRAWINGS

Exemplary embodiments described herein are described with reference to the appended figures, wherein the like elements are numbered alike, and in which elements are not necessarily depicted to scale. Dimensions in the figures are only exemplary, and are in inches. To assist those of ordinary skill in the art in making and using the disclosed systems, assemblies, methods, and uses, reference is made to the appended figures, wherein:

FIG. 1 is a cross-sectional side-view of an embodiment of a liquid handling probe assembly, according to the present disclosure;

FIG. 2 is an end view of the assembly of FIG. 1;

FIG. 3 is a partial side-view of another embodiment of a tip of a liquid handling probe assembly, according to the present disclosure;

FIG. 4 is a cross-sectional side-view through A-A of the assembly of FIG. 3; and FIG. 5 is an end view of the assembly of FIG. 3;

FIG. 6 is a partial side view of another embodiment of the tip of a liquid handling probe assembly, according to the present disclosure;

FIG. 7 is a cross-sectional side-view of the tip of the assembly of FIG. 6 through lines A-A;

FIG. 8 is an end view of the assembly of FIG. 6;

FIG. 9 is a partial section view of a tube of a liquid handling probe assembly, according to the present disclosure; and

FIG. 10 is an end view of the tube of FIG. 9.

### DETAILED DESCRIPTION

The present disclosure provides liquid handling probe assemblies having porous and solid structures, and related methods of fabrication and use. In particular, the present disclosure provides designs and fabrication methods to improve the longevity and/or performance of the liquid handling probe assemblies.

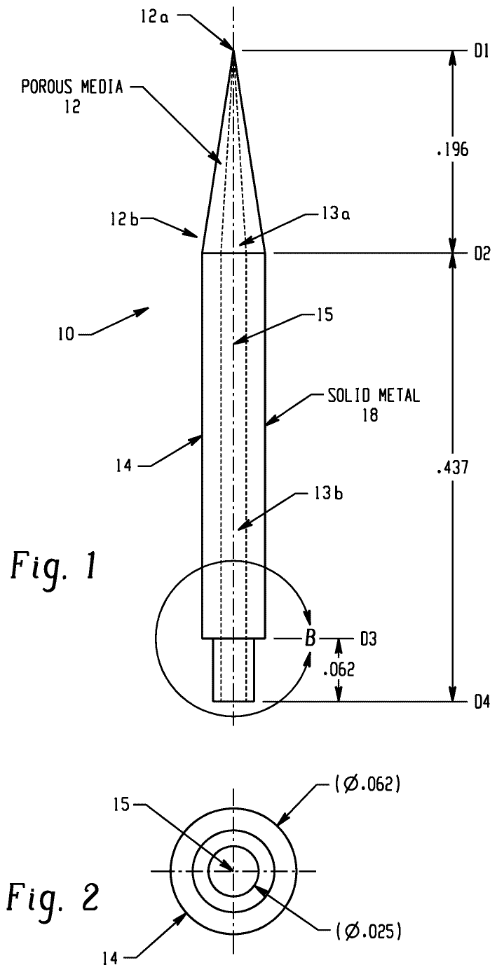

FIG. 1 is a cross-sectional side-view of an exemplary liquid handling probe assembly 10. As shown, liquid handling probe assembly 10 includes a porous metal tip 12 adjacent a first (distal) end of a tube 14 having a center portion, for example a hollow center 13b in fluid communication with the tip 12. Tip 12 can be in the shape of a cone as shown in FIG. 1, or have another shape, for example a cylinder, square, or polygon. The tip 12 can have any cross-sectional form, including elliptical, triangular, square, rectanglular, or other polygonal form. In another aspect, tip 12 has a cross-sectional shape configured to fit an opening a container for a liquid, for example a circular diameter smaller than the opening of a container for a liquid, or a shape corresponding to the shape of an opening of a container for a liquid.

In an aspect, tip 12 can be sharp at apex end 12a, as shown in FIG. 1, i.e., have a piercing configuration that can pierce a material such as a rubber, silicone, polytetrafluoroethylene (PTFE) septum or covering, a foil covering, or other covering of a container for a liquid. To form the piercing configuration, the tip, for example the apex end 12a, can have an angled configuration or an evenly tapered configuration as shown in FIG. 1, or both. Exemplary piercing configurations include needle configurations, i.e., needle shapes.

Tip 12 comprises a porous metal material at least at the apex end 12a, and preferably at both the apex end 12a the base end 12b of the tip. In an aspect, tip 12 has a porous gradient from an outer diameter to a center line 15 thereof. In an aspect, the porous gradient is a continuous or a step-wise gradient from the outer diameter toward the centerline 15, being higher porosity (less dense) at the outer diameter and lower porosity (more dense) toward the centerline 15. In another aspect, the porous gradient is continuous or stepwise from the apex end 12a to the base end 12b, being higher porosity (less dense) at the apex end 12a and lower porosity (more dense) toward the base end 12b. Use of a porous gradient can provide additional strength to the tip, with the desired degree of porosity to filter particulates when a liquid is drawn through the tip. Use of a porous gradient can also improve filtration and/or prevent fouling of the tip, where larger particles are blocked at the outer surface.

Tip 12 can further include a lumen 13a at centerline 15. As shown in FIG. 1 and FIG. 2, lumen 13a can be open to the distal end of solid metal tube 14 at base end 12b, and be contiguous with hollow center 13b. In an aspect, apex end 12a to base end 12b of tip 12 comprises only the porous metal media, i.e., does not contain a direct opening to hollow center 13b. A continuous or stepwise gradient as described above can be present in the tip 12 even if a lumen is present.

Tube 14 comprises at least a solid metal wall 18 on the outside thereof, to maintain mechanical integrity of the liquid handling probe assembly. Although shown as a circular cross-section, the solid metal outer wall 18 can have any cross-sectional form, including elliptical, triangular, square, rectangular, or other polygonal form. In an aspect, the inner diameter of the solid wall forms the hollow center 13b for receiving liquid from tip 12. The second end of tube 14 can be configured to mate with commercial sampling equipment, or other liquid transfer/analysis equipment.

In another embodiment, either the tip 12 or the tube 14, or both, do not include a lumen or a hollow center. For example, tip 12 can comprise the porous metal with no lumen. In this or other embodiments, the tube can comprise the porous metal withing the solid metal wall 118 in place of the hollow space along the centerline 15, or a porous metal itself having a hollow space along the centerline 15. In any of these embodiments the porous metal of tip 12, tube 14, or both can comprise a continuous stepwise porosity gradient from an outer to an inner diameter, either from less porous to more porous (from denser to less dense), or from more porous to less porous (from less dense to denser), wherein the density or density gradient of the tip 12 and tube 14 can be the same or different. For example, the porous tip can have a first porosity or density (e.g., a higher porosity and lower density) or density gradient, and the porous metal core of the tube 14 can have a second porosity or density (e.g., a lower porosity and a higher density) or density gradient different from the tip 12.

While suitable for some uses, in some embodiments, the geometry of the assemblies 10 with tip 12 can be insufficient in mechanical strength in certain uses. For example, regardless of the porosity (density) or density gradient of tip 12, the tip 12 can break off or become damaged during post-manufacture processing, or may not function well to penetrate sample vial through a septum or cover.

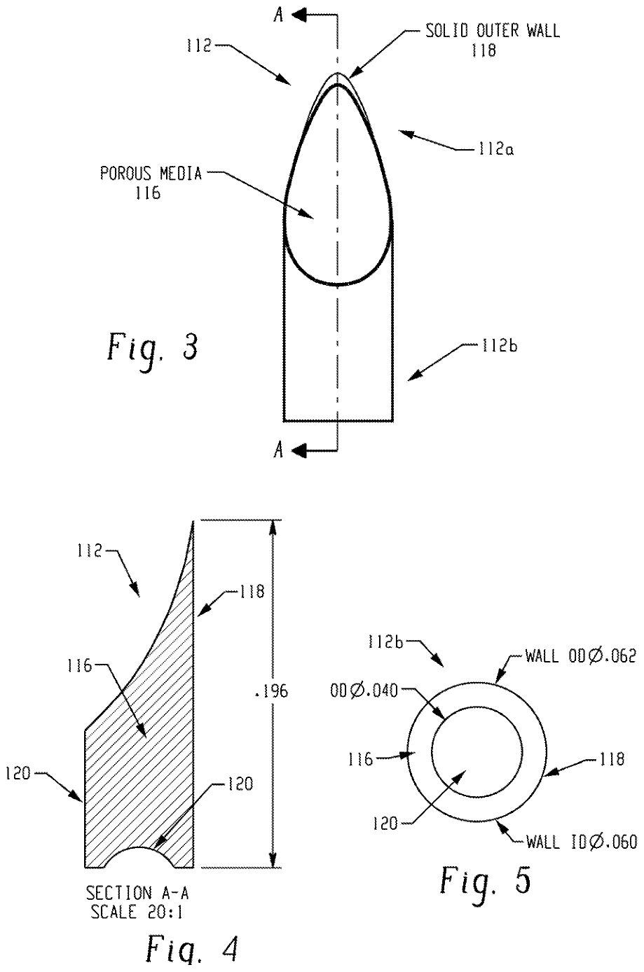

An improved exemplary embodiment of tip 112 for a liquid handling probe assembly is shown at FIG. 3, FIG. 4, and FIG. 5. As shown in the partial side view of tip 112 in FIG. 3, end 112a of tip 112 in the form of a tapered and angled needle, i.e., a form that can readily pierce a material such as a rubber septum, foil covering, or other covering of a container for a liquid. Tip 112 comprises a porous metal portion 116 (i.e., a porous core with no lumen) partially supported by, for example partially surrounded by the solid metal portion 118. The porous metal portion 116 can have a uniform porosity or density, or the porous metal portion 116 can have a porosity gradient as described above, in a direction from the outer diameter to the inner diameter, or in a direction from the apex end 112a toward base end 112b. In a specific embodiment, the porous core has a continuous or stepwise gradient of higher porosity (lower density) at apex end 112a and lower porosity (higher density) toward base end 112b. As shown in the cross-sectional view of FIG. 4, the porous core is both tapered to tip 112a, and angled from the base of the base end 112b toward apex end 112a. In other embodiments, the tip can simply be angled or uniformly tapered.

FIG. 4 further shows a cavity 120 located within tip 212 at the base end 212b. It has been found that the cavity 120 having an appropriate diameter, such as 1.0 mm (0.04 inch as shown in FIG. 4) or height, enables use of laser powder bed fusion printing to manufacture the tip without the need for any support structure during manufacture. The cavity 220 is distinguished from a lumen as described above, e.g, 13a, by its length from the base end to the tip end. For example, a cavity 120 is less than 50%, less than 25%, less than 15%, or less than 10% of the length of the tip. The cavity can be of any cross-section, for example, part of a sphere (e.g., hemispherical or a smaller cross-section), square, conic, rectangular, or ovoid. In an embodiment, the cavity is hemispherical.

The solid metal portion 118 is directly adjacent, for example on, the porous metal portion 116 and provides mechanical support for the porous metal portion, thus enhancing the mechanical integrity of the tip 112. The solid metal portion can be of any form, including bars, grids, annular shapes, crescent shapes, or the like. In an embodiment, the solid metal support 118 comprises a first portion that surrounds the base end of the porous metal tip 112b, or a second portion that partially surrounds the apex end 112a of the porous metal tip, preferably both. The solid metal portion 120 at apex end 112a can be coterminal with the porous metal apex end 112a. In another embodiment, the first solid metal portion 118 of the tip extends slightly past the end of the porous metal tip portion 112a to still further improve mechanical strength of apex end 112a, to provide additional piercing capability, or both. It has been found that use of the tapered or angled needle shape of porous metal portion 116, shielded on the outside diameter by a solid wall 118, significantly improved the strength of the probe tips 112, while maintaining the required porosity. For example, no tips 112 broke during post-processing steps, and the tips 112 were not damaged, bent, or broken after intentionally applying force (pushing with hand) on a hard surface (wood table).

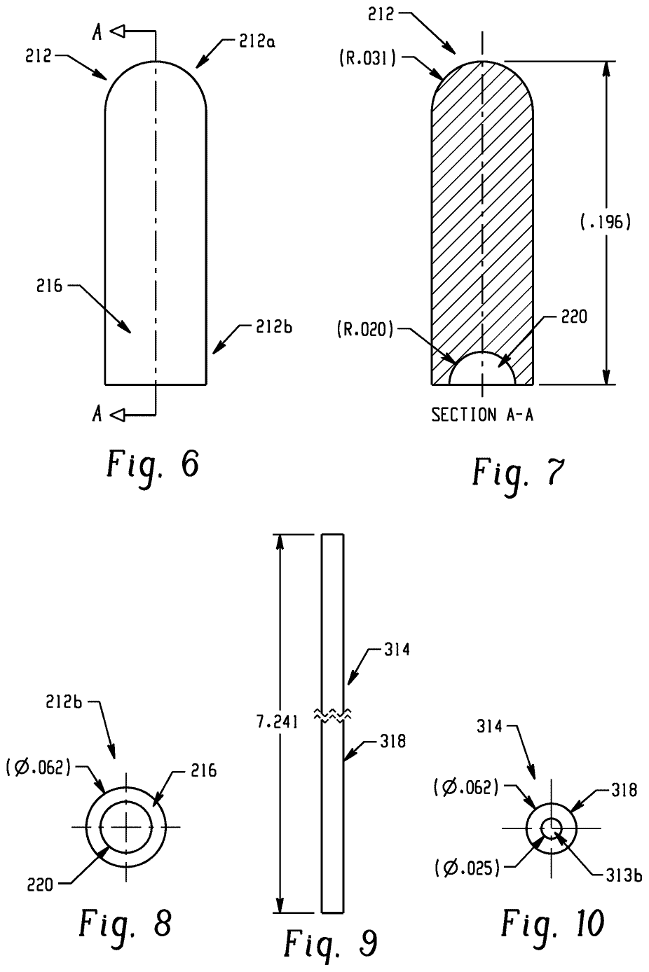

Another exemplary embodiment of a tip for the liquid handling probe assemblies is shown at FIG. 6, FIG. 7, and FIG. 8. In this embodiment as shown in FIG. 6 and FIG. 7, tip 212 is non-piercing, i.e., rounded at the apex 212a. Other non-piercing configurations can be used, for example, square, oval, or the like. In addition, tip 212 as shown is wholly porous, i.e., contains no solid metal support disposed thereon, and no lumen is present therein. Optionally, a lumen can be present, provided that the apex end 212a is a porous metal of a thickness effective to prevent or substantially decrease entry of particulates or in the liquid or undesired liquid phases. Use of a fully porous tip such as 212 increases the available surface area for liquid uptake.

FIG. 7 further shows a cavity 220 located within tip 212 at the base end (base) 212b. The cavity 220 can have the same characteristics as cavity 120. It has been found that the cavity 220 having an appropriate size, for example a radius such as 0.5 mm (0.02 inch as shown in FIG. 7), enables use of laser powder bed fusion printing to manufacture the tip without the need for any support structure during manufacture.

FIG. 9 and FIG. 10 show an exemplary embodiment of a tube 314 that can be used with any of the tips to provide the liquid handling probe assemblies described herein. Tube 314 comprises a solid metal defining a center, in particular a hollow center 313b spanning the length of the tube 314, as described above. The tube can be of a diameter and length that can be laser printed as described below, to achieve an overall probe diameter and length that can be integrated into existing liquid sampling equipment. For example, as shown in FIG. 10, the outer diameter of the tube can be 1.57 mm (0.62 inches); the center hollow portion can have a diameter of 064 mm 0. (0.25 inches); and the tube can have a length of 183.9 mm (7.24 inches).

The diameters, lengths, and other dimensions of the liquid handling probe assemblies can be varied in accordance with the intended use of the assemblies, in particular the volume of liquid to be transferred, the viscosity of the liquid, and like considerations. In exemplary embodiments, the tips can be 0.5-10 millimeters (mm) long from apex end to base end, for example 1-8 mm long, or 0.55 mm (0.2 inches) long (the distance from D1 to D2 in FIG. 2). The outside diameter of the tip at the base end is preferably selected to match the outside diameter of the tube at the first end.

The tube, e.g., tube 14, 314, can be of any convenient length, for example 1-500 mm long from first end to second end, or 5-250 mm long, or 8-200 mm long, or 8-100 mm long, or 8 to 50 mm long (the distance from D2 to D4 in FIG. 1).

The outside diameter of the tube, e.g., tube 14, 314, can be from 0.1-10 mm, for example 0.5 to 5 mm, or 1 to 3 mm, such as 1.5 mm (0.06 inches or 0.062 inches). In an embodiment, the outside diameter of the tube does not vary along the length of the tube. In another embodiment the outside diameter of the tube can vary, for example from smaller at the first end to larger at the second end. In an embodiment, the outside diameter (and the corresponding diameter of the center for passage of a fluid) can be enlarged to provide additions storage capacity for the liquid.

The outside diameter of the lumen (e.g., 13a) at the base end (e.g., 12b) of the tip or the outside diameter of the center for passage of a fluid of the tube (e.g., hollow center 13b, 313b) can be adjusted to provide the desired volume of liquid during transfer. For example, the outside diameter of the lumen at the base end of the tip or at the center of the tube (e.g., hollow center 13b, 313b) can be from 0.05 to less than 10 mm, for example 0.5-5 mm, or 0.5-3 mm, such as 0.06 mm (0.025 inches) or 1 mm (0.04 inches).

When present, the cavity (e.g., 120, 220) can have a radius or length from the base end toward the apex end of less than 50%, preferably less than 25%, or less than 15%, or less than 10%, of the length of the tip from the apex end to the base end. It has been found that the cavity 220 having an appropriate size, for example a radius or length such as 0.01 to less than 5 mm (0.0004-0.2 inches), or 0.05-3 mm (0.002-0.11 inches) or 0.1-1 mm (0.004-0.039 inches), or 0.5 mm (0.02 inch).

As stated above, in an embodiment, the tip (e.g., 112, 212) has no lumen 13a, and the tube has a hollow center (e.g., 13b, 313b) or a porous metal center that allows the passage of a fluid, or a porous metal center surrounding a hollow center. In these embodiments, the porous metal center of the tube, or the hollow center of the porous metal tube can have the diameters as set forth above for the lumen at the base of the tip (e.g., 13a) or of the hollow center of the tube (e.g., 13b, 313b). In an embodiment, the outside diameter of the lumen (e.g., 13a) at the base end (e.g., 12b) of the tip and the outside diameter of the center for passage of a fluid of the tube (e.g., hollow center 13b, 313b) is the same. It is also possible for the outer diameter at the hollow center (e.g., 13b, 313b) to vary along the length of the tube, for example from smaller at the first end or larger at the second end, or to be enlarged to provide additional liquid storage capacity.

The solid metal (e.g., 14, 118) can be of any thickness sufficient to provide the desired structural integrity. For example, the thickness of the solid metal structure 14, 118 can be from 0.1-1 mm, or 0.2 to 0.8 mm.

Nominal pore sizes of tips are variable, ranging from 0.01-500 micrometers, or 0.1 to micrometers to over 100 micrometers, for example 0.1-100 micrometers, or 0.2 micrometers to over 100 micrometers, for example 0.2-100 micrometers.

Manufacturing (fabrication) methods of the liquid handling probe assemblies 10, 110 include additive manufacturing (i.e., 3D printing). A particularly useful method is laser powder bed fusion (LPBF). LPBF is a fabrication method that enables the resolution of small features, controlled porosity, controlled porosity gradients, and solid-porous transitions. The components (e.g., tip 12, 112, 212 and tube 14, 314) of the liquid handling probe assemblies, (e.g., 10, 110), can be manufactured at the same time. Alternatively, the tip can be fabricated separately and affixed to the tube, or other long tube structure mating to existing liquid handling probe equipment for use.

The porous metal of the tip or of the porous metal core of tube 4, or both, can be fabricated from a variety of metals or alloys of metals, such as aluminum, beryllium, copper, iron, magnesium, nickel, niobium, titanium, tungsten, zinc, or an alloy thereof, such as a nickel alloy, stainless steel, or the like. Similarly, the solid metal can be fabricated from a variety of metals or alloys of metals, such as aluminum, beryllium, copper, iron, magnesium, nickel, niobium, titanium, tungsten, zinc, or an alloy thereof, such as a nickel alloy, stainless steel, or the like. Stainless steel is especially useful.

A method of transferring a liquid using the above-described liquid handling probe assemblies includes contacting the apex end of the tip comprising a porous metal with a liquid to be transferred; drawing the liquid into the tip; drawing the liquid from the tip to the center of the tube; and optionally, drawing the liquid from the second end of the tube. Drawing can be, for example by means of a vacuum or capillary action. The transferred liquid in the tube or from the second end of the tube can then be analyzed or further processed. A multiplicity of the liquid handling probe assemblies can be used to simultaneously transfer fluids or fluid samples from a multiplicity of containers. In particular, the above-described assemblies with porous metal tips can be used for liquid handling/sampling probe applications, for example for in situ measurements of reaction kinetics, or for any of a wide range of sampling conditions in which the samples contain suspended solids or liquid phases that need to be excluded from the liquid to be transferred for analysis or sampling. In an advantageous feature, the monitoring can be on-line, rather than, for example, by current process analytical tool such as sampling followed by analysis (e.g., by chromatographic methods such as gas-liquid chromatography (GLC) or high-pressure liquid chromatography (HPLC)). Such on-line measurements are especially useful in systems with rapidly changing conditions or rapidly changing species, for example during phase changes (e.g., formation of emulsions or crystallizations) or during chemical reactions. (See, e.g., Hein, et al. “A robust new tool for online solution-phase sampling of crystallizations” Reaction Chemistry Engineering (2021) (DOI: 10.1039/d1re00284h).

In an embodiment, the porous media of porous metal tips (and optionally the tubes) enables liquid-liquid, liquid-solid, and/or aqueous-organic separations.

### Examples

The liquid handling probe assemblies were tested in accordance with the methods described in previous work using pressed-sintered porous media (Hein, et al. “A robust new tool for online solution-phase sampling of crystallizations” Reaction Chemistry Engineering (2021) (DOI: 10.1039/d1re00284h)) reported several advantages to incorporating porous media in selective solution-phase sampling. The advantages are in comparison to manual sampling and ex situ sampling methods that are common with process analytical technology (PAT) tools.

In one set of experiments Hein et. al. tested the ability of the filter tip to selectively sample the solution-phase of a heterogeneous mixture. It was found that the pressed-sintered porous filter tip could provide accurate concentration data with little noise and was able to do so over extended periods. See, FIG. 4 in Hein et al., DOI: 10.1039/d1re00284h.

The accuracy and precision of the concentration data from the porous filter was further tested via dosing of isopropyl alcohol (IPA) into a tetrabenazine (TBZ) solution. It was shown that the porous filter tip was able to differentiate the dissolution and dilution processes. The drastic change of solvent composition typically leads to complicated analysis with chemometric tools, yet with the use of the porous filter tip, only HPLC monitoring was required. See, FIG. 5 in Hein, et al., DOI: 10.1039/d1re00284h.

Another series of tests explored the filter tip's ability to sample under supersaturated conditions of water dosed into TBZ in IPA. The quality of the concentration data was consistently high even through temperature-induced supersaturation and crystallization events. This also worked well while monitoring multiple solution phase components. See, FIGS. 6, 7 and 8 in Hein, et al., DOI: 10.1039/d1re00284h.

The table below shows data from a variety of LPBF parameter settings applied to the porous tip region during manufacture. The liquid handling probes were fabricated from 316L stainless steel. The size and shape of the cavity varied based on which probe geometry was used (i.e., FIG. 1, 4, or 7). For the table presented below, the cavity 220 in FIG. 7 with a radius of 0.51 mm (0.020 inches) was used. The apex end for this set of data was dome-shaped, as shown in FIG. 7 at 212 with a radius of 0.79 mm (0.031 inches). Overall, the porous tip was 4.98 mm (0.196 inches) long with an outer diameter of at the base of 1.57 mm (0.062 inches).

The “original groups” exhibited media grade equivalent designations of 20 and 60. “Media Grade Equivalent” refers to bubble point test results per ASTM E-128 and ISO4003, correlated to conventionally pressed-sintered porous media. The number designation associated with each grade represents the nominal pore size within the media.

The “new groups” were fabricated to span a variety of permeability values within the “original groups” as a means to provide tunability of the pore structures of the probe tips. This tuneability can enable specific end uses in sampling and separation applications, targeting different aqueous and organic phase mixtures.

| | | | Media Grade | N₂ Flow at | Permeability |
|---|---|---|---|---|---|
| Print Set | Group | BPT (inches H₂O) | Equivalent | 5 PSIG (SLPM) | (m²) |
| Original Groups | 3 | 5.87 ± 1.00 | 20 | 1.68 ± 0.27 | 2.43E−12 |
| | 5 | 2.53 ± 0.41 | 60 | 3.71 ± 0.19 | 5.34E−12 |
| New Groups | 1 | 3.56 ± 0.22 | 40 | 3.14 ± 0.32 | 4.53E−12 |
| | 2 | 3.46 ± 0.31 | 40 | 2.52 ± 0.26 | 3.63E−12 |
| | 3 | 3.68 ± 0.21 | 40 | 2.60 ± 0.38 | 3.74E−12 |
| | 4 | 3.50 ± 0.26 | 40 | 2.43 ± 0.07 | 3.51E−12 |
| | 5 | 5.12 ± 0.06 | 20 | 2.05 ± 0.53 | 2.96E−12 |
| | 6 | 4.42 ± 0.83 | 20-40 | 1.46 ± 0.12 | 2.11E−12 |

BPT: Bubble point (a pore-size measurement technique as described in ASTM E-128 and ISO4003.
PSIG: pounds per inches gauge
M²: meters squared

This data shows the ability of our LPBF to fine-tune the permeability of the porous probe as well as the pore-size (i.e., media grade equivalent), or alternatively to adjust the permeability while maintaining an equivalent media grade designation. The “original groups” were identified as min and max boundaries based on empirically derived performance criteria, given one specific liquid-liquid separation application. The “new groups” were developed to offer a variety of discrete permeability settings within that original range as a means to optimize the probe performance for said application. This highlights the ability of the technique to offer rapid iterations in the development stages of an end use product.

The ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Although the assemblies, systems and methods have been described herein with reference to exemplary embodiments thereof, the present disclosure is not limited to such embodiments and/or implementations. Rather, the assemblies, systems, and methods are susceptible to many implementations and applications, as will be readily apparent to persons skilled in the art from the disclosure hereof. This disclosure expressly encompasses such modifications, enhancements, and/or variations of the disclosed embodiments. Since many changes could be made in the above construction and many widely different embodiments could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and, in a manner consistent with the scope of the disclosure.

1. A liquid handling probe assembly comprising
a tip comprising a porous metal for passage of a fluid and having an apex end and a base end, wherein at least the apex end of the tip comprises the porous metal; and
a tube having a first end and a second end, the tube comprising a solid metal that defines a center for passage of a fluid, wherein the base end of the porous metal tip is adjacent the first end the tube and in fluid communication therewith.

2. The liquid handling probe assembly of claim 1, wherein the porous metal tip has no lumen, and comprises a cavity at the base end.

3. The liquid handling probe assembly of claim 1, wherein the porous metal tip at the apex of the tip comprises a piercing configuration for piercing a cover of a container including a liquid.

4. The liquid handling probe assembly of claim 1, wherein the apex end is angled, tapered, or both to provide the piercing configuration.

5. The liquid handling probe assembly of claim 1, wherein the apex end is in a non-piercing configuration.

6. The liquid handling probe assembly of claim 1, wherein the porous metal of the porous metal tip defines a lumen in the tip.

7. The liquid handling probe assembly of claim 1, wherein the porous metal of the porous metal tip does not define a lumen in the tip.

8. The liquid handling probe assembly of claim 1, wherein the porous metal tip further comprises a solid metal support that partially surrounds the tip.

9. The liquid handling probe assembly of claim 8, wherein the solid metal support comprises a first portion that surrounds the base end of the porous metal tip.

10. The liquid handling probe assembly of claim 9, wherein the solid metal support further comprises a second portion that supports or partially surrounds the apex end of the porous metal tip.

11. The liquid handling probe assembly of claim 1, wherein the porous metal of the tip comprises a porosity gradient from the apex end to the base end, wherein the porosity is greater at the apex end than at the base end.

12. The liquid handling probe assembly of claim 1, wherein the center of the tube for passage of a fluid is hollow.

13. The liquid handling probe assembly of claim 1, wherein the center of the tube for passage of a fluid comprises a porous metal core.

14. The liquid handling probe assembly of claim 13, wherein the porous metal of the tip has a first porosity and the porous metal core has a second porosity, wherein the first porosity of the porous metal of the tip is greater than the second porosity of the porous metal core.

15. The liquid handling probe assembly of claim 13, wherein the porous metal core of the tube comprises a hollow center for passage of the liquid.

16. A method of transferring a liquid, comprising
contacting the apex end of the tip comprising the porous metal of the liquid handling probe assembly of claim 1 with a liquid to be transferred;
drawing the liquid into the tip;
drawing the liquid from the tip to the center of the tube; and
optionally, drawing the liquid from the second end of the tube.

17. The method of claim 16, wherein the apex end of the tip pierces a cover of a container in which the liquid is disposed.

18. A method for fabricating the liquid handling probe assembly of claim 1, comprising additively manufacturing at least a portion of the assembly.

19. The method of claim 18, wherein at least the porous metal tip of the assembly is additively manufactured.

20. The method of claim 19, wherein the additive manufacturing comprises laser powder bed fusion.
